(19) United States
(12) Patent Application Publication
(10) Pub. No.: US 2006/0192341 A1
(43) Pub. Date: Aug. 31, 2006

(54) CAM shaft oil seal and manufacturing method thereof

(75) Inventor: Ji Min Yoon, Suwon-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(73) Assignee: Hyundai Motor Company

(21) Appl. No.: 11/414,597

(22) Filed: Apr. 28, 2006

Related U.S. Application Data
(62) Division of application No. 11/016,525, filed on Dec. 17, 2004.

(30) Foreign Application Priority Data
Dec. 17, 2003 (KR) 10-2003-0092354

(51) Int. Cl. F16J 15/34; F16J 15/36

(52) U.S. Cl. 277/306; 277/366; 277/367; 277/392

(57) ABSTRACT

A method for manufacturing a cam shaft oil seal comprising a ring-shaped metal member, an inner rubber member connected to the ring-shaped metal member and contacting an outer surface of a cam shaft, and an outer rubber member connected to the ring-shaped metal member and contacting a bearing cap. The method included pouring heated rubber material into a mold after the ring-shaped metal member is disposed within the mold and applying heat in a first specified temperature for a first specified time range and then applying heat in a second specified temperature for a second time. Thereafter a surface treatment is performed for the inner rubber member and the outer rubber member formed on the metal member and a ring-shaped coil spring is installed on an outer surface of the inner rubber member.

### CROSS REFERENCE TO RELATED APPLICATION

This application claims priority of Korean Application No. 10-2003-0092354, filed on Dec. 17, 2003, the disclosure of which is incorporated herein by reference.

### TECHNICAL FIELD OF THE INVENTION

The present invention relates to a cam shaft oil seal and a manufacturing method thereof.

### BACKGROUND OF THE INVENTION

A cam shaft oil seal for preventing leakage of oil is provided at an end portion of a cam shaft that drives the intake and exhaust valves of an engine of a vehicle. Such a cam shaft oil seal is generally disposed to contact the cam shaft bearing cap that is installed at an end of the cam shaft.

In a typical arrangement, a cam shaft oil seal includes a ring-shaped metal member and inner and outer rubber members coupled to the ring-shaped metal member through a compression forming process. A ring-shaped spring urges the inner rubber member against the cam shaft. In the forming process, a rubber layer is formed on an inner surface of the ring-shaped metal member so the amount of rubber material needed is increased. Also, additional work is needed to remove such an extra rubber layer.

In such conventional methods, it is difficult to form precisely the cam shaft oil seal because of characteristics of the compression forming process. Also, an amount of rubber is wasted and extra time expended due to the rubber layer formed on the inside of the metal ring.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Embodiments of the present invention provide a seal and methods for manufacturing in which the cam shaft oil seal is formed through an injection molding.

An exemplary embodiment of the present invention includes a cam shaft oil seal comprising a ring-shaped metal member, an inner rubber member connected to the ring-shaped metal member and contacting an outer surface of a cam shaft, and an outer rubber member connected to the ring-shaped metal member and contacting a bearing cap. An exemplary method according to the invention includes: pouring heated rubber material into a mold in a state in which the ring-shaped metal member is disposed within the mold; applying heat in a temperature range of 90 to 110 degrees Celsius for a time range of 210 to 220 seconds to the poured rubber material; applying heat in a temperature range of 190 to 210 degrees Celsius for approximately 20 hours to the poured rubber material; performing a surface treatment for the inner rubber member and the outer rubber member formed on the metal member; and installing a ring-shaped coil spring on an outer surface of the inner rubber member.

In a further embodiment of the present invention, a cam shaft oil seal comprises: a ring-shaped metal member; an inner rubber member connected to the ring-shaped metal member and contacting an outer surface of a cam shaft; and an outer rubber member connected to the ring-shaped metal member and contacting a bearing cap. The metal member may comprise a first extending part extending in a direction perpendicular to a longitudinal direction of the cam shaft and a second extending part extending from an end portion of the first extending part in the longitudinal direction of the cam shaft. The inner rubber member is connected to an inner end portion of the first extending part and the outer rubber member covers a portion of the first extending part and an outer surface of the second extending part without covering an inner surface of the second extending part.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 is a sectional view of a cam shaft oil seal according to an embodiment of the present invention;

FIG. 2 is a flowchart showing a method for manufacturing a cam shaft oil seal according to an embodiment of the present invention; and

FIG. 3 shows schematically a state in which a metal member is disposed within a mold in the process of a method for manufacturing a cam shaft oil seal according to an embodiment of the present invention.

### DETAILED DESCRIPTION OF THE PREFERRED EMBODIMENTS

Hereinafter, an embodiment of the present invention will be described in detail with reference to the accompanying drawings.

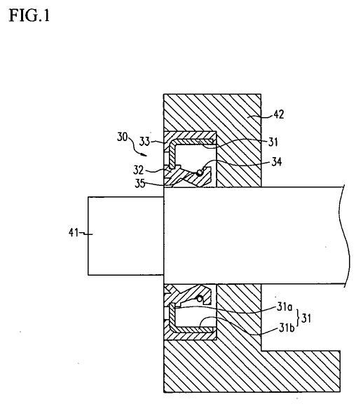

Reference numeral 30 in FIG. 1 generally denotes a cam shaft oil seal according to an embodiment of the present invention. The cam shaft oil seal 30 includes a ring-shaped metal member 31, and an inner rubber member 32 and an outer rubber member 33 that are formed to be connected to the ring-shaped metal member 31.

The cam shaft oil seal 30 may be installed near a bearing mounting portion of a cam shaft 41. As shown in FIG. 1, the cam shaft oil seal 30 is connected to the cam shaft 41 to be adjacent to a cam shaft bearing cap 42.

A sealing can be improved by urging the inner rubber member 32 to contact an outer surface of the cam shaft 41 using a ring-shaped coil spring 34. For this structure, as shown in FIG. 1, a coil spring receiving groove 35 is formed on an outer surface of the inner rubber member 32, and the ring-shaped coil spring 34 is inserted into the coil spring receiving groove 35. Accordingly, sealing between the inner rubber member 32 and the outer surface of the cam shaft 41 can be improved.

The ring-shaped metal member 31 is provided for maintaining overall shape, and it may include, as shown in FIG. 1, a first extending part 31a that is formed by extending in a direction perpendicular to a longitudinal direction of the cam shaft 41, and a second extending part 31b that is formed by extending in a direction perpendicular to the first extending part 31a, that is, in the longitudinal direction of the cam shaft 41.

As shown in FIG. 1, the inner rubber member 32 is connected to an inner end of the fist extending part 31a, and the outer rubber member 33 is formed to cover a portion of the fist extending part 31a and the whole outer surface of the second extending part 31b. That is, in one embodiment, being different from the conventional cam shaft oil seal as shown in FIG. 4, the outer rubber member 33 does not cover an inner surface of the second extending part 31b. Therefore, a work for removing a rubber layer that is remained on an inner surface of a metal member is not needed, so that the overall manufacturing process becomes simpler and an amount of rubber material needed for manufacturing the seal can be reduced.

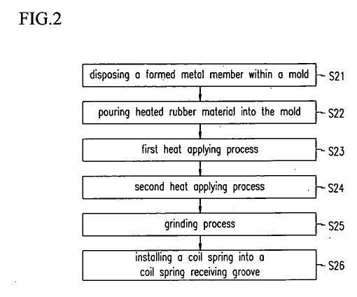

Referring to FIG. 2, a method for manufacturing a cam shaft oil seal according to an embodiment of the present invention will be explained hereinbelow.

The ring-shaped metal member 31 may be formed through various forming processes as is obvious in the art.

The inner rubber member 32 and the outer rubber member 33 may be formed through an injection molding method.

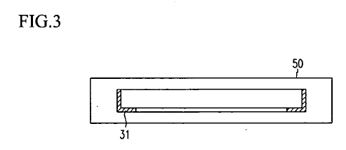

At first, as shown in FIG. 3, at step S21, the formed metal member 31 is disposed within a mold 50 configured to be suitable for forming the inner and outer rubber members 32 and 33. Subsequently, heated rubber material is poured into the mold 50 to form the inner and outer rubber members 32 and 33.

After the performing of the step S21, first and second heat applying processes S23 and S24 are performed such that the rubber material can be formed in the mold 50.

For example, during the first heat applying process, heat in a temperature range of 90 to 110 degrees Celsius is applied to the poured rubber material for a time range of 210 to 220 seconds. According to applicant's experiments, if heat of 100 degrees Celsius is applied for 215 seconds, or if heat of 110 degrees Celsius is applied for 210 seconds, a rate of defective cam shaft oil seals becomes particularly low.

During the second heat applying process, heat in a temperature range of 190 to 210 degrees Celsius is applied to the poured rubber material for about 20 hours. According to applicant's experiments, if heat of 200 degrees Celsius is applied for 20 hours, a rate of defective cam shaft oil seals becomes particularly low.

Then, at step S25, a grinding process for a surface treatment for the inner rubber member 32 and the outer rubber member 33, that are formed on the metal member 31, is performed.

After the grinding process, the coil spring 34 is installed into the coil spring receiving groove 35 formed on the outer surface of the inner rubber member 32 at step S26.

As stated above, the conventional compression forming method has a problem that a rubber layer may be remained on an inner surface of the metal member, but according to a manufacturing method according to an embodiment of the present invention, a rubber layer is not formed on the second extending part 31b of the metal member 31. Therefore, an amount of rubber material can be saved, and a cam shaft oil seal that does not have an unnecessary rubber layer can be manufactured.

According to a method for manufacturing a cam shaft oil seal of an embodiment of the present invention, the rubber members are formed through an injection molding rather than a conventional compression forming method, so that a work for removing a rubber layer remained on the metal member is not needed and an amount of rubber material can be reduced.

Although embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A manufacturing method of a cam shaft oil seal comprising a ring-shaped metal member, an inner rubber member connected to the ring-shaped metal member and contacting an outer surface of a cam shaft, and an outer rubber member connected to the ring-shaped metal member and contacting a bearing cap, the method comprising:
pouring heated rubber material into a mold in a state in which the ring-shaped metal member is disposed within the mold;
applying heat in a temperature range of 90 to 110 degrees Celsius for a time range of 210 to 220 seconds to the poured rubber material;
applying heat in a temperature range of 190 to 210 degrees Celsius for approximately 20 hours to the poured rubber material;
performing a surface treatment for the inner rubber member and the outer rubber member formed on the metal member; and
installing a ring-shaped coil spring on an outer surface of the inner rubber member.

2. (canceled)
